(19) United States
(12) Patent Application Publication
(10) Pub. No.: US 2001/0056288 A1
(43) Pub. Date: Dec. 27, 2001

(54) Book

(76) Inventor: Celia Holman, London (GB)

Correspondence Address: PEARNE & GORDON LLP, 526 SUPERIOR AVENUE EAST, SUITE 1200, CLEVELAND, OH, 44114-1484, US

(21) Appl. No.: 09/833,999

(22) Filed: Apr. 12, 2001

(30) Foreign Application Priority Data
Apr. 12, 2000 (GB) 0009232.0

(51) Int. Cl. A61J 17/00

(52) U.S. Cl. 606/235

(57) ABSTRACT

The invention relates to a book 1, comprising a plurality of pages 2, held by a spine 3, and a non-toxic chewable part 4 attached thereto.

This application relates to a book, and in particular to a book for an infant.

It is generally recognised that it is important to start children as young as possible with books. However, a problem which most parents will be familiar with is that young children can be less than careful with books, often destroying them quickly and completely. One approach to meeting this problem has been to provide books with thicker than normal pages, made for example from card, and laminated with a slimy moisture resistant surface layer. However, it has been found that a determined youngster can deal with these expedients successfully and in a relatively short space of time by employing their teeth.

It is an object of the present invention to mitigate problems such as this.

According to the invention there is provided a book, comprising a plurality of pages held by a spine, and a non-toxic chewable part attached thereto.

It is preferred that the said part is resilient, preferably formed from a plastics or rubber material. It is especially preferred that the said part includes at least one hollow, sealed section, which can be filled with a liquid or gel.

The said part may be releasably attached to the pages, and in particular it is preferred that the said part is releasably attached by strap means. The strap means may attach the said part adjacent to the spine of the book, preferably by passing through one aperture in the pages.

The said part may include raised surface formations, to increase its attractiveness to chewing.

The invention will further be described by way of example, and with reference to the accompanying drawings, in which:

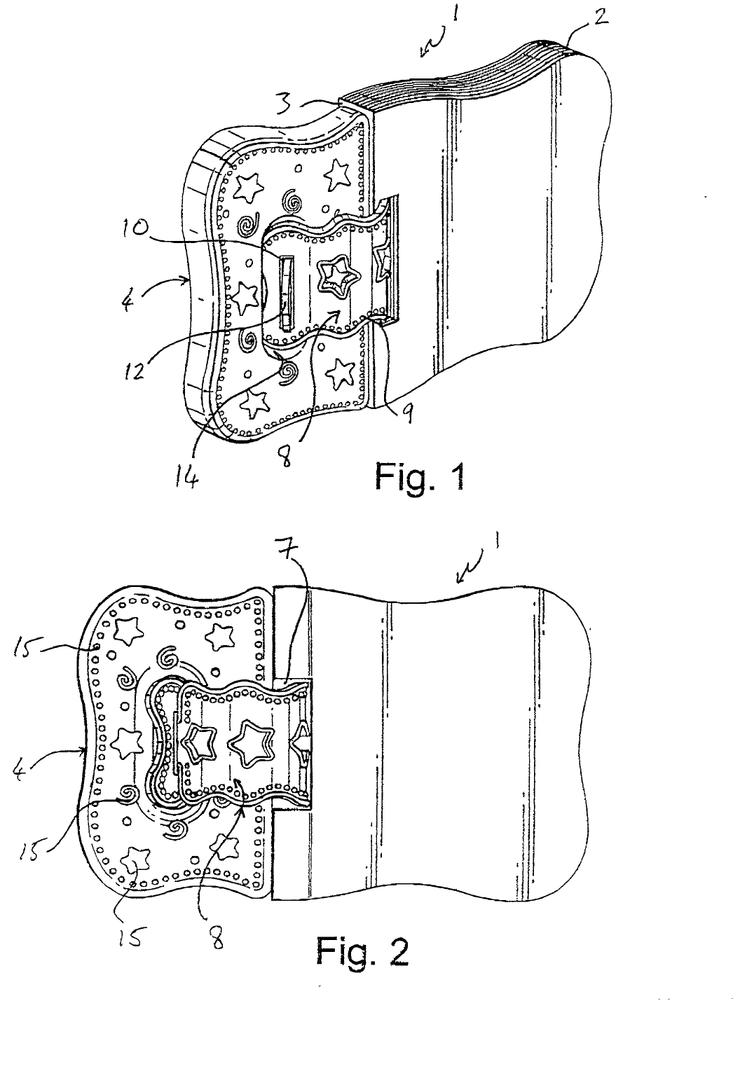

FIG. 1 is a front perspective view of a book according to the invention;

FIG. 2 is a front view of the book of FIG. 1;

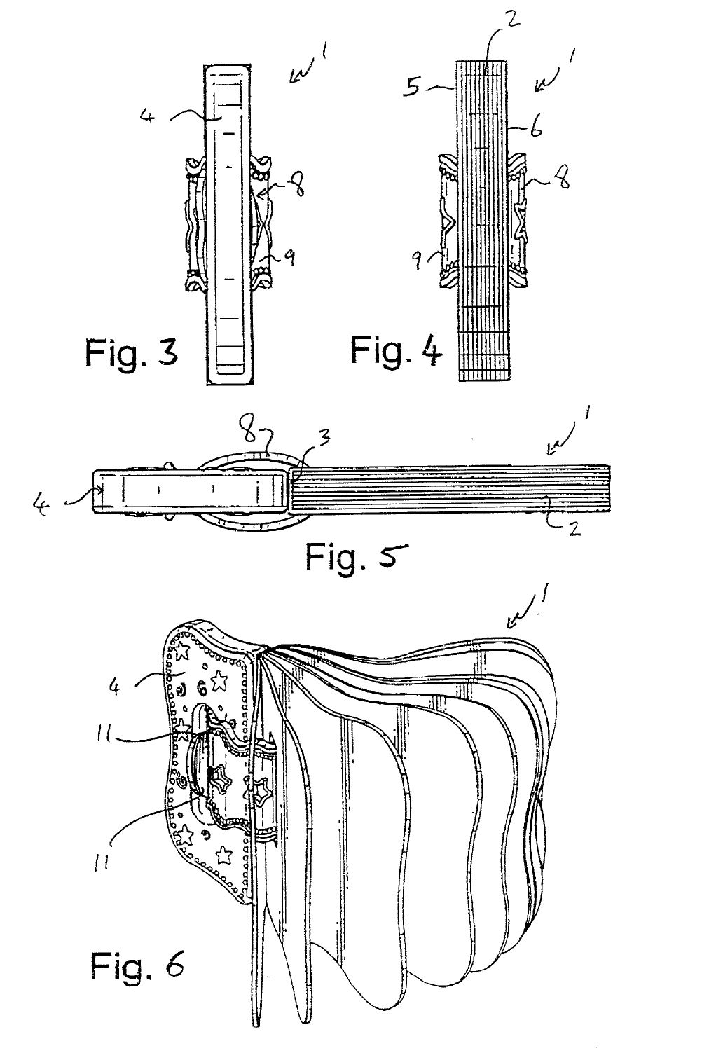

FIG. 3 is a left-side view of the book of FIG. 1;

FIG. 4 is a right-side view of the book of FIG. 1;

FIG. 5 is a plan view of the book of FIG. 1; and

FIG. 6 is a right front perspective view of the book of FIG. 1 in an alternative position.

Referring to the drawings there is illustrated a book 1, comprising a plurality of pages 2 held by a spine 3, and a non-toxic chewable part 4 attached thereto.

The pages 2 are formed from relatively thick card, and laminated as is known in the art, with a smooth surface layer to protect the card from moisture. In this embodiment the book 1 has front and back covers 5,6 which are formed from one continuous piece of card which extends from front to back and provides the spine 3 to which the pages 2 are attached as is known in the art.

Adjacent the spine 3, a substantially rectangular through aperture 7 is provided which passes through all of the pages 2 from front to back.

Attachment means 8 is passed through the aperture 7, in the form of a plastic strap 9, one end including a slot 10, and the other including a tab 12. The tab 12 has side lugs 11 (FIG. 6) at its end. The strap 9 is used to secure a chewable part 4 to the pages 2. The chewable part 4 comprises a laterally compressed substantially flat and rectangular ring, with a lozenge-shaped aperture 14 at its centre. The ring 4 is hollow, formed from a non-toxic plastics material and filled with water, so that it is resiliently compressible with the fingers, and indeed, the gums.

The ring 4 is attached to the pages 2 in side by side relation via the strap 9, which is passed through the aperture 14. The lugs 11 of the tab 12 can then be passed through the slot 10, one after the other, whereupon the tab 12 will be prevented from coming away from the slot 10 inadvertently.

The ring 13 is provided with raised surface decorations 15, which in this embodiment take the form of stars and abstract shapes. These decorations 15 make the ring 13 more satisfying to chew on.

1. A book, comprising a plurality of pages held by a spine, and a non-toxic chewable part attached thereto.

2. A book according to claim 1, wherein the chewable part is resilient.

3. A book according to claim 1 or claim 2, wherein the chewable part comprises a plastics or rubber material.

4. A book according to any preceding claim, wherein the chewable part includes at least one hollow, sealed section which can be filled with a liquid or gel.

5. A book according to any preceding claim, wherein the chewable part is releasably attached to the pages.

6. A book according to claim 5, including a releasable strap for attaching the chewable part to the pages.

7. A book according to claim 6, wherein the strap attaches the chewable part adjacent to the spine.

8. A book according to claim 6 or claim 7, wherein the releasable strap attaches the chewable part to the pages by passing through an aperture in the pages.

9. A book according to any preceding claim, the chewable part including raised surface formations.

10. A book substantially as hereinbefore described with reference to the accompanying drawings.
